(19) United States
(12) Patent Application Publication
(10) Pub. No.: US 2011/0299312 A1
(43) Pub. Date: Dec. 8, 2011

(54) INVERTER FOR SOLAR CELL ARRAY

(75) Inventors: Douglas W. Karraker, Muskego, WI (US); Kalyan P. Gokhale, New Berlin, WI (US); Matti T. Jussila, Vantaa (FI)

(73) Assignee: ABB Inc., Cary, NC (US)

(21) Appl. No.: 13/151,766

(22) Filed: Jun. 2, 2011

Related U.S. Application Data
(60) Provisional application No. 61/352,072, filed on Jun. 7, 2010.

(51) Int. Cl. H02M 7/5387

(52) U.S. Cl. 363/132

(57) ABSTRACT

A full-bridge, NPC inverter uses pulse width modulation (PWM) to convert the DC voltage from a solar panel array to an AC voltage at the output of the inverter that is acceptable for connection to a utility. The PWM control unit has a predetermined carrier frequency. The carrier unit uses for each carrier period either positive or negative values of a reference voltage to generate a predetermined number of signals to control the switching on and off of each of the eight inverter switching elements in a predetermined pattern for a predetermined period of the carrier frequency period to thereby produce the acceptable alternating current voltage at the inverter output and not produce between the inverter input and earth ground a carrier frequency component.

### CROSS REFERENCE TO RELATED APPLICATION

This application claims the priority of U.S. provisional patent application Ser. No. 61/352,072 filed on Jun. 7, 2010, entitled “Inverter For Solar Array” the contents of which are relied upon and incorporated herein by reference in their entirety, and the benefit of priority under 35 U.S.C. 119(e) is hereby claimed.

### 1. FIELD OF THE INVENTION

This invention relates to an inverter for use with a solar cell array.

### 2. DESCRIPTION OF THE PRIOR ART

A solar panel array consists of series connected solar cells. A photovoltaic (PV) inverter converts DC voltage from the solar panel array to AC voltage for connection to the utility.

The typical system for an ungrounded photovoltaic system is shown in FIG. 1. As is shown in FIG. 1, the output DC voltage, U_{DC}, from the solar panel array PV is connected to the inputs of an inverter. The DC voltage is converted to the AC utility voltage U_{AB} at the inverter output using pulse width modulation (PWM). The PWM Control Unit controls the inverter switches to produce the desired PWM scheme. The solar panel PV is coupled to earth ground through parasitic capacitance, C_{pvg}, between the panel and the grounded frame, not shown, that mechanically supports the panel.

The voltage U_{N} in FIG. 1 at the inverter negative input with respect to earth ground is a function of the inverter topology and the PWM scheme used to control the inverter to convert the DC voltage to the AC utility voltage U_{AB}. The voltage, U_{N}, across the capacitor C_{pvg}, is the common mode voltage of the PV array with respect to ground. Any AC component of the voltage U_{N} will generate a current through the capacitor C_{PVg} from the solar panel cells to ground. If the voltage U_{N} across the capacitor contains excessive high frequency (“HF”) components, it can produce excessive high frequency ground currents. These high frequency currents can also damage the solar panel.

Referring now to FIG. 2, there is shown an H-bridge inverter. The inverter which has four switches designated as S1, S2, S3 and S4 in FIG. 2, is controlled using fixed frequency PWM. The PWM Control Unit shown in FIG. 1 can be used to control the inverter switches to produce the desired PWM scheme.

FIG. 3 illustrates for a particular example the waveforms associated with the operation described below of the H-bridge inverter shown in FIG. 2. It should be noted that in this example only six (6) carrier periods are used for each cycle of the utility voltage U_{g}. In practice, the carrier frequency is much higher: such as 10 KHz to 20 KHz for a utility frequency of 50 Hz or 60 Hz.

For each PWM carrier period, a desired average line-line voltage, U_{ref} is chosen as is shown by one of the first of the waveforms in FIG. 3. The voltage U_{ref} is varied to approximate a sinusoid over the period of the utility voltage U_{g} which is also shown in the first of the waveforms in FIG. 3.

For positive values of U_{ref}, switch S1 is turned on for a part of the carrier period and switch S4 is turned on for the entire carrier period (see the third waveform in FIG. 3 for S1 and the sixth waveform in FIG. 3 for S4) and switch S2 is turned off for a part of the carrier period and the switch S3 is turned off for the entire carrier period (see the fourth waveform in FIG. 3 for S2 and the fifth waveform in FIG. 3 for S3). This on and off arrangement of the switches applies U_{DC}, the DC voltage from the solar panel array, at the inverter outputs as the voltage U_{AB} which is shown in the second waveform of FIG. 3. This is an active voltage state.

For the remainder of each of the carrier periods for positive values of U_{ref}, S1 is turned off and S2 is turned on while as described above S3 continues to remain off and S4 continues to remain on. This on and off arrangement of the switches applies approximately zero voltage at the inverter outputs, U_{AB}. This is a zero state.

A sequence similar to that described above for positive values of the desired average line-line voltage is used for negative values of U_{ref} where −U_{DC} is applied to the inverter outputs for part of the carrier period (active state) and zero voltage is applied for the remainder (zero state).

The common mode voltage, U_{N} in FIG. 2 and shown in the seventh waveform of FIG. 3, can be approximated with the assumption that U_{L1} and U_{L2}, the voltage across each of the two inductors shown in FIG. 1, are approximately equal:

U_{L}≈U_{L1}≈U_{L2}

During the positive active state when U_{AB}=+U_{DC} (S1 and S4 on), the following equations apply:

U_{AB}=U_{DC}=U_{g}+2U_{L}

U_{N}=−U_{L}

During the negative active state when U_{AB}=−U_{DC} (S2 and S3 on), the following equations apply:

U_{AB}=−U_{DC}=U_{g}+2U_{L}

U_{N}=−U_{DC}−U_{L}

In both active states, eliminating U_{L} from the equation for U_{N} gives:

$${U}_{N} = ( \frac{{U}_{g} - {U}_{DC}}{2} ) \qquad ( Eq . 1 )$$

When S2 and S4 are turned on to produce a zero state at the inverter output:

U_{AB}=0=U_{g}+2U_{L}

U_{N}=−U_{L}

$${U}_{N} = ( \frac{{U}_{g} - {U}_{DC}}{2} ) + \frac{{U}_{DC}}{2} \qquad ( Eq . 2 )$$

When S1 and S3 are turned on to produce a zero state at the inverter output:

U_{AB}=0=U_{g}+2U_{L}

U_{N}=−U_{DC}−U_{L}

$${U}_{N} = ( \frac{{U}_{g} - {U}_{DC}}{2} ) - \frac{{U}_{DC}}{2} \qquad ( Eq . 3 )$$

As can be seen from equations 1, 2 and 3, the common mode voltage U_{N} has a step change equal to U_{DC}/2 every time there is a transition from an active state to a zero state and vice-versa. The total voltage, U_{N}, has three components: DC, utility frequency (50 Hz or 60 Hz) and carrier frequency (10 KHz-20 KHz). The carrier frequency component is the undesirable part of the common mode voltage. The waveform for U_{N} is shown in FIG. 3.

Various topologies have been used to mitigate this high frequency component of the common mode voltage including but not limited to the H5 inverter shown in U.S. Pat. No. 7,411,802 and the HERIC inverter shown in EP 1369985B1. Both of these inverter topologies add extra transistors to allow isolation between the DC bus and the utility during the time that the zero voltage state is applied. The resultant common mode voltage for both of these inverters is given by the equation:

$${U}_{N} = \frac{{U}_{g} - {U}_{DC}}{2}$$

and is independent of the active and zero states. Therefore, the common mode voltage has only DC and utility frequency components.

Another topology that has been used is the Half-bridge 3-level Neutral Point Clamped (“NPC”) inverter shown in FIG. 4.

In this topology, the voltage U_{N}, the voltage at the negative terminal of the panel with respect to ground, is equal to −U_{DC}/2 since the mid point of the inverter DC bus formed by the series connection of the DC bus capacitors is connected to earth ground. The main drawback of this topology is that the total DC bus voltage must be at least twice that of the peak of the utility voltage. Therefore, for a 230V rms (325V peak) utility voltage the DC bus must be a minimum of 650 Vdc.

### SUMMARY OF THE INVENTION

A full-bridge neutral point clamped (NPC) inverter having an input and an output converts a direct current voltage at the inverter input to an alternating current voltage at the inverter output acceptable for connection to a utility. The inverter includes eight switching elements S1 to S8 with switching elements S1 to S4 forming a first half of the NPC inverter full-bridge and the switching elements S5 to S8 forming a second half of the NPC inverter full-bridge inverter. The inverter further includes a pulse width modulator control unit having a predetermined carrier frequency. The control unit using for each carrier period either positive or negative values of a reference voltage to generate a predetermined number of signals to control the switching on and off of each of the eight switching elements in a predetermined pattern for a predetermined period of the carrier frequency period to thereby produce the alternating current voltage at the inverter output acceptable for connection to the utility and not produce between the inverter input and earth ground a carrier frequency component.

### DESCRIPTION OF THE DRAWING

FIG. 1 shows a schematic of a prior art PV system with stray capacitance.

FIG. 2 shows a schematic of a prior art H-bridge inverter.

FIG. 3 shows an exemplary voltage modulation using an H-bridge.

FIG. 4 shows a schematic of a prior art 3-level NPC inverter.

FIG. 5 shows a schematic of a full bridge NPC inverter.

FIG. 6 shows a modulation scheme for eliminating high frequency signals using eight control signals.

FIG. 7 shows a modulation scheme for eliminating high frequency signals using four unique control signals.

### DETAILED DESCRIPTION

There is described herein another technique to eliminate the high frequency component in the common mode voltage. This technique uses the inverter topology shown in FIG. 5. This topology is known as the Full-bridge, NPC inverter. This topology is presently used in medium voltage drives to reduce the voltage across the individual transistors. The modulation scheme used in that application produces a five level output and the five level operation of the inverter contains high frequency components in the voltage U_{N} between the inverter input and earth ground. Therefore as used in MV drives the full-bridge, NPC inverter of FIG. 5 does not eliminate the HF common mode voltage.

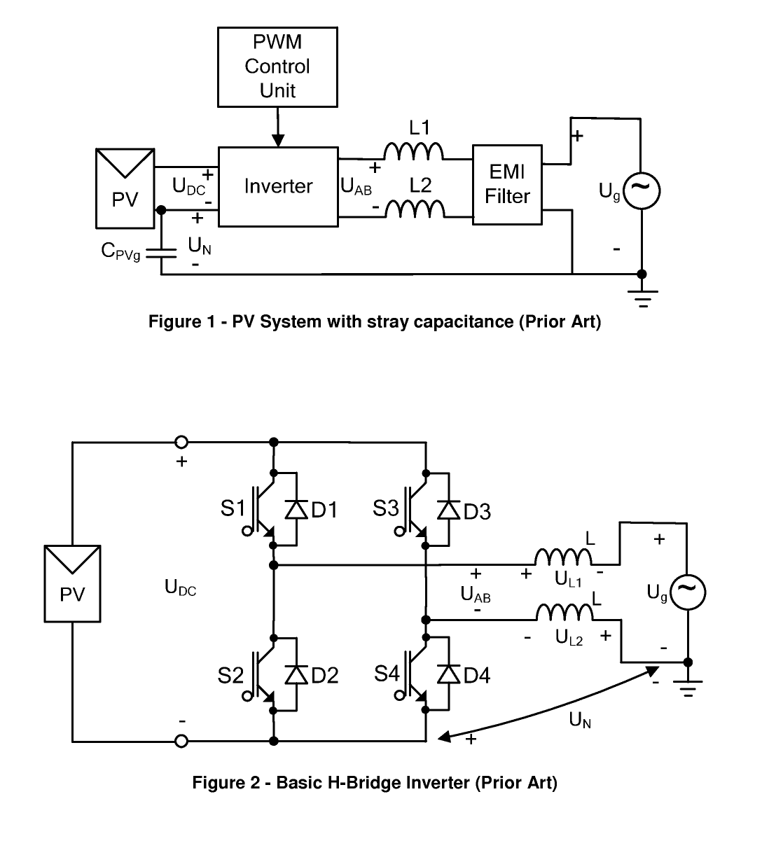

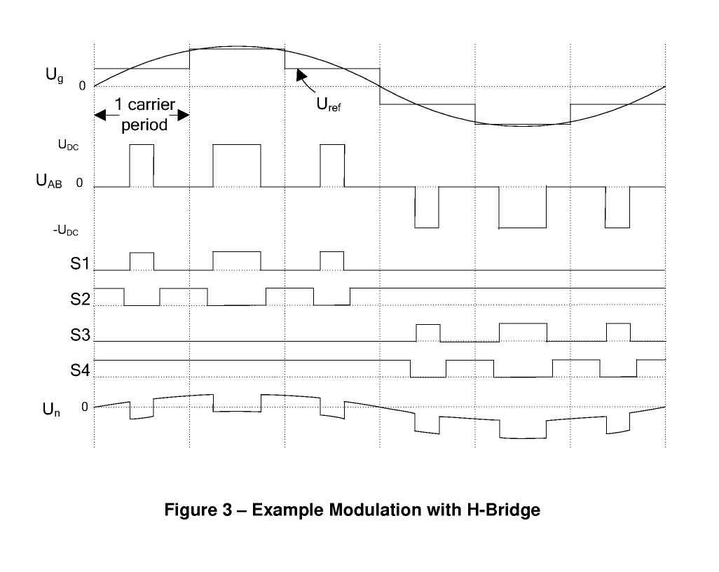

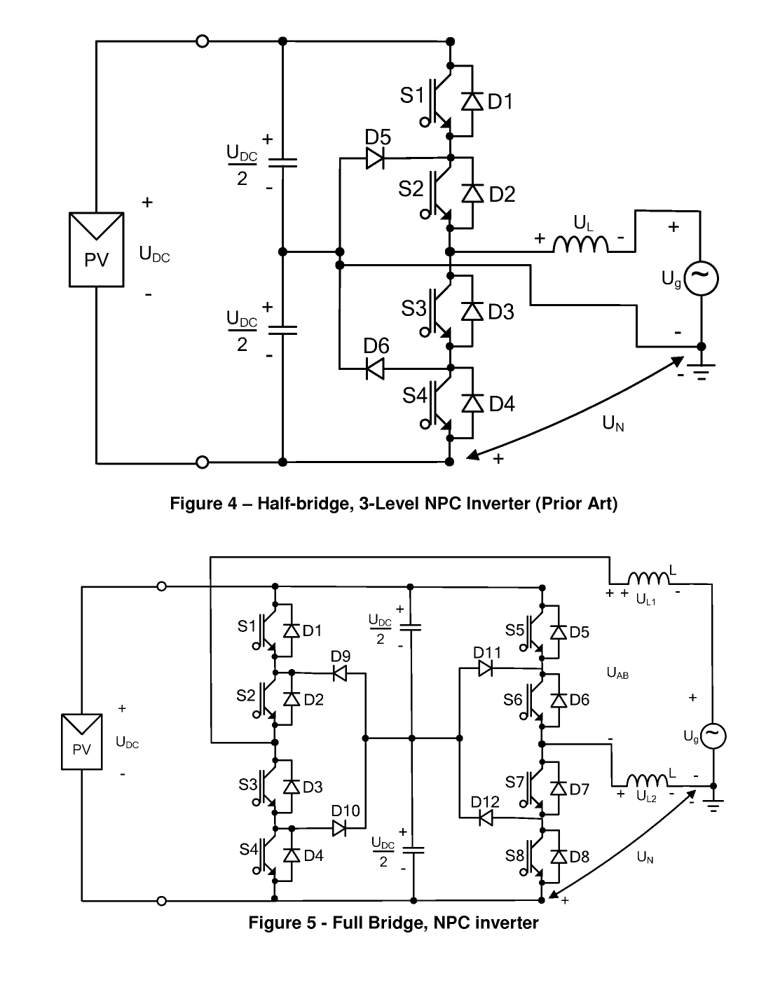

In contrast, the use of the full-bridge NPC inverter as shown in FIG. 5 with a solar panel array PV in the manner described below eliminates the HF common mode voltage. The full-bridge NPC inverter is controlled using fixed frequency PWM. The PWM Control Unit shown in FIG. 1 can be used to control the inverter switches to produce the desired PWM scheme. Each PWM carrier period, a desired average line-line voltage, U_{ref}, is chosen so that the average voltages approximate a sinusoid over the period of the utility voltage.

For each carrier period, the reference voltage, U_{ref}, is obtained, on average, by applying an active voltage across the inverter output (U_{AB}) equal to +U_{DC} or −U_{DC} for part of the period and a zero voltage the remainder of the period. The fraction of the carrier period that the active voltage is applied is the duty cycle and is determined by the equation:

$$duty cycle ( k ) = \frac{\vert {U}_{ref} ( k ) \vert}{{U}_{dc}} \qquad Eq . 4$$

The selection of the eight transistors shown in FIG. 5 that are used to apply these voltages is described below.

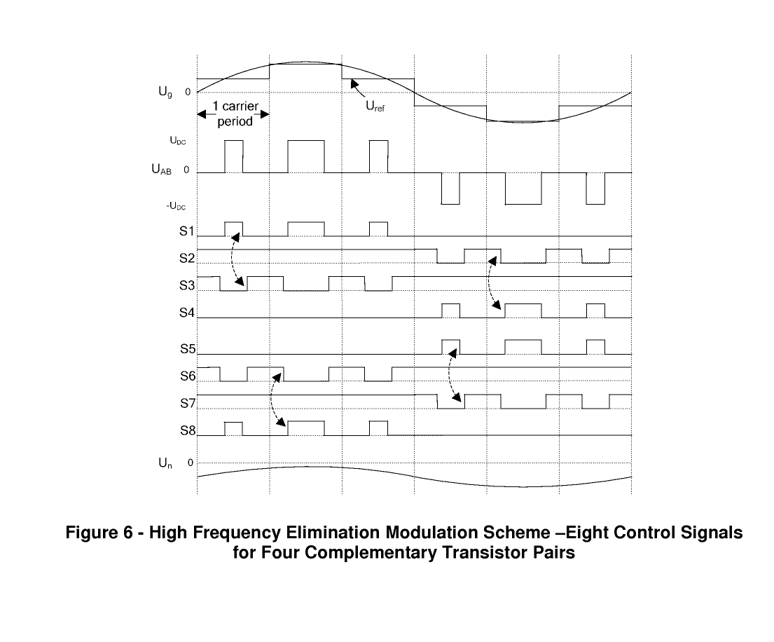

The waveforms for this modulation scheme are shown in FIG. 6. For ease of illustration, the carrier frequency shown is lower than would actually be used.

The topology shown in FIG. 5 has eight transistors S1 to S8. The states of the transistors to eliminate the HF component are:

1) The transistors S1, S4, S5 and S8 form the active voltage states when U_{AB}=+U_{DC} or −U_{DC}.

2) The transistors S2, S3, S6 and S7 form the zero voltage state when U_{AB}=0. Some of these transistors are also on during the active voltage state.

3) For positive values of U_{ref}, S1, S2, S7 and S8 are on and S3, S4, S5 and S6 are off to produce the active state (U_{AB}=+U_{DC}) per equation 4. For the zero voltage state, S2, S3, S6 and S7 are on and S1, S4, S5 and S8 are off for the remainder of the carrier period.

4) For negative values of U_{ref}, S3, S4, S5 and S6 are on to produce the active state (U_{AB}=−U_{DC}) per equation 4. For the zero voltage state, S2, S3, S6 and S7 are on and S1, S4, S5 and S8 are off for the remainder of the carrier period.

5) For each of the eight transistors there is a corresponding transistor that cannot be turned on at the same time to prevent short circuiting the DC bus to the DC bus midpoint. These pairs of transistors are called complementary transistor pairs. The switching pattern in FIG. 6 shows that there are 4 complementary pairs indicated by the dashed lines with arrows in that figure that connect the pairs. These complementary transistor pairs are: S1/S3; S4/S2; S5/S7; S8/S6. As is shown in FIG. 6, the two transistors in the S1/S3 pair cannot both be on at the same time that S2 is on; the two transistors in the S4/S2 pair cannot both be on at the same time that S3 is on; the two transistors in the S5/S7 pair cannot both be on at the same time that S6 is on; and the two transistors in the S8/S6 pair cannot both be on at the same time that S7 is on. Thus transistors S1, S2 and S3 cannot all be on at the same time, transistors S2, S3 and S4 cannot all be on at the same time, transistors S5, S6 and S7 cannot all be on at the same time, and transistors S6, S7 and S8 cannot all be on at the same time.

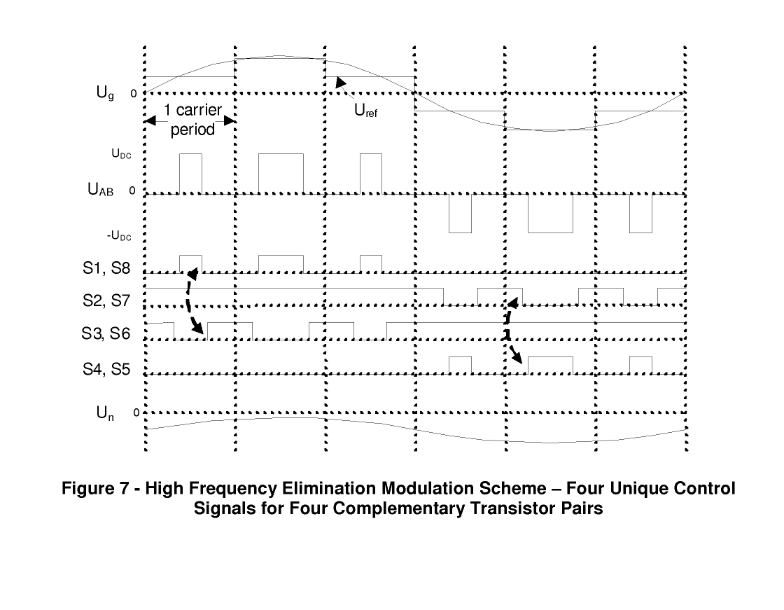

6) Each transistor shown in FIG. 5 is turned on or off with a control signal. FIG. 6 shows eight (8) separate control signals, the waveforms identified as S1 to S8, to control the four (4) complementary transistor pairs. While eight (8) control signals are shown in FIG. 6, it should be appreciated that only four (4) unique signals are required. To produce the waveform U_{g} in FIG. 6, the complementary transistor pairs S1/S3 and S8/S6 must be controlled with the same control signals. Likewise, the complementary transistor pairs S4/S2 and S5/S7 must be controlled with the same signals. Therefore, to produce this waveform U_{g}, only four (4) unique control signals are needed as shown by the waveforms in FIG. 7.

7) This particular modulation example shows a center based PWM where the active voltage +U_{DC} or −U_{DC} is applied in the center of the carrier period and the zero voltage is split equally between the beginning and the end of the carrier period. There are many other ways to split these voltages including selecting the active and zero voltage durations separately for each half carrier period. It should be appreciated that how the active and zero voltage states are split in a carrier period does not affect the operation of the full-bridge NPC inverter to eliminate the HF component in the common mode voltage provided that the active and zero transistor states are selected as described above.

During the active voltage state of the carrier period (U_{AB}=+U_{DC} or −U_{DC}), the same derivation used for equation 1 shows that the common mode voltage U_{N} is:

$${U}_{N} = \frac{{U}_{g} - {U}_{DC}}{2} \qquad ( Eq . 5 )$$

During the zero voltage state, both inverter outputs are approximately equal to −U_{L}.

Therefore, the following equations apply:

U_{AB}=0=U_{g}+2U_{L}

$${U}_{N} = - {U}_{L} - \frac{{U}_{DC}}{2}$$

For the zero state, eliminating U_{L} from the equation for U_{N} gives:

$${U}_{N} = \frac{{U}_{g} - {U}_{DC}}{2} . \qquad ( Eq . 6 )$$

Equations 5 and 6 are identical. Therefore, for the inverter topology shown in FIG. 5 that is controlled to have the active and zero transistor states described above, the common mode voltage, U_{N}, does not exhibit any abrupt changes when the inverter output state changes from active to zero or vice-versa. Thus, the common mode voltage, U_{N}, does not contain any undesired high frequency components.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A full-bridge neutral point clamped (NPC) inverter having an input and an output for converting a direct current voltage at said inverter input to an alternating current voltage at said inverter output acceptable for connection to a utility, said NPC full-bridge inverter comprising:
eight switching elements S1 to S8, said switching elements S1 to S4 forming a first half of said NPC inverter full-bridge and said switching elements S5 to S8 forming a second half of said NPC inverter full-bridge inverter; and
a pulse width modulator control unit having a predetermined carrier frequency, said control unit using for each carrier period either positive or negative values of a reference voltage to generate a predetermined number of signals to control the switching on and off of each of said eight switching elements in a predetermined pattern for a predetermined period of said carrier frequency period to thereby produce said alternating current voltage at said inverter output acceptable for connection to said utility and not produce between said inverter input and earth ground a carrier frequency component.

2. The full-bridge NPC inverter of claim 1 wherein said inverter output is connected to a utility whose voltage has a predetermined period and said reference voltage positive or negative values are selected for each carrier period to approximate a sinusoid over said utility voltage predetermined period.

3. The full-bridge NPC inverter of claim 1 wherein said switching elements S1, S4, S5 and S8 form an active voltage state when said voltage at said inverter output is equal to either a positive or negative value of said DC voltage at said inverter input and said switching elements S2, S3, S6 and S7 form a zero voltage state when said voltage at said inverter output is equal to zero.

4. The full-bridge NPC inverter of claim 3 wherein for all of said carrier periods for which said reference voltage has a positive value said switching elements S2 and S7 are always on, said switching elements S4 and S5 are always off, said switching elements S1 and S3 switch in opposition to each other and said switching elements S6 and S8 switch in opposition to each other to thereby produce said active voltage state when S1, S2, S7 and S8 are on and S3, S4, S5 and S6 are off and said zero voltage state when S2, S3, S6 and S7 are on and S1, S4, S5 and S8 are off.

5. The full-bridge NPC inverter of claim 3 wherein for all of said carrier periods for which said reference voltage has a negative value said switching elements S1 and S8 are always off, said switching elements S3 and S6 are always on, said switching elements S2 and S4 switch in opposition to each other and said switching elements S5 and S7 switch in opposition to each other to thereby produce said active voltage state when S3, S4, S5 and S6 are on and S1, S2, S7 and S8 are off and said zero voltage state when S2, S3, S6 and S7 are on and S1, S4, S5 and S8 are off.

6. The full-bridge NPC inverter of claim 1 wherein said eight switching elements are arranged in four complementary pairs S1/S3, S4/S2, S5/S7, and S8/S6 of said switching elements where said S1 and S2 switching elements cannot both be on at the same time that said switching element S2 is on, said S4 and S2 switching elements cannot be both on at the same time that said switching element S3 is on, said S5 and S7 switching elements cannot be both on at the same time that said switching element S6 is on and said S8 and S6 switching elements cannot be both on at the same time that said switching element S7 is on.

7. The full-bridge NPC inverter of claim 1 wherein said switching elements S1, S2 and S3 cannot all be on at the same time, said switching elements S2, S3 and S4 cannot all be on at the same time, said switching elements S5, S6 and S7 cannot all be on at the same time and said switching elements S6, S7 and S8 cannot all be on at the same time.
